(19) United States
(12) Patent Application Publication
(10) Pub. No.: US 2026/0292794 A1
(43) Pub. Date: Sep. 24, 2026

(54) SYSTEM AND APPARATUS FOR RESOURCE ALLOCATION IN A NETWORK AND A METHOD IN ASSOCIATION THERETO

(71) Applicant: Continental Automotive Technologies GmbH, Hannover (DE)

(72) Inventors: David GONZALEZ GONZALEZ, Egelsbach, Hessen (DE); Osvaldo GONSA, Frankfurt (DE); Andreas ANDRAE, Frankfurt am Main (DE); Rikin SHAH, Langen, Hessen (DE); Hojin KIM, Regensburg (DE)

(73) Assignee: Continental Automotive Technologies GmbH, Hannover (DE)

(21) Appl. No.: 19/472,497

(22) PCT Filed: Apr. 4, 2024
(86) PCT No.: PCT/EP2024/059127

§ 371 Date: Oct. 3, 2025

(30) Foreign Application Priority Data
Apr. 6, 2023 (DE) 10 2023 203 230.9

(51) Int. Cl. H04W 72/0446; H04W 28/26; H04W 72/25; H04W 72/52

(52) U.S. Cl. CPC H04W 72/0446; H04W 28/26; H04W 72/25; H04W 72/52

(57) ABSTRACT

A system, an apparatus, and a method for resource allocation in a network. The method includes receiving a signal associated with resource reservation; determining a number of transmissions and a time period between each of the transmissions based on the received signal; and transmitting resources based on the number of transmissions and the time period.

### CROSS REFERENCE TO RELATED APPLICATIONS

This application is the U.S. National Phase Application of PCT International Application No. PCT/EP2024/059127, filed Apr. 4, 2024, which claims priority to German Patent Application No. 10 2023 203 230.9, filed Apr. 6, 2023, the contents of such applications being incorporated by reference herein.

### FIELD OF INVENTION

The present disclosure generally relates to one or both of a system and an apparatus for resource allocation in a network in association with, for example, a User Equipment (UE) usable for communication. The present disclosure further relates a method which can be associated with the system and/or the apparatus.

### BACKGROUND OF INVENTION

Generally, energy efficiency and power saving would be helpful in communication networks, for example, a 3rd Generation Partnership Project (3GPP) 5G (fifth generation) New Radio (NR) standard-based telecommunications network.

Current techniques may determine a number of transmissions differently depending on the type of transmission, for example New Radio (NR) and Long Term Evolution (LTE). This may affect the NR-based sidelink and LTE-based sidelink co-channel co-existence negatively, such as conflicts in resource selection. Thus, the current techniques may not facilitate energy efficiency and power saving in an optimal manner.

The present disclosure contemplates that it would be helpful to address or at least mitigate one or more issues in relation to conventional techniques for facilitating energy efficiency and power saving when allocating resources in a network.

### SUMMARY OF THE INVENTION

According to a first aspect of the present invention, there is provided a method for resource allocation in a network, the method comprising receiving a signal associated with resource reservation; determining a number of transmissions and a time period between each of the transmissions based on the received signal; and transmitting resources based on the number of transmissions and the time period.

Advantageously, the method as described herein can provide efficiency in resource reservation and allocation and can allow energy efficiency and power saving in a network.

In an embodiment, the method further includes allocating resources for transmission based on the number of transmissions and the time period.

In an embodiment, determining the number of transmissions comprises determining the number of transmissions based on a maximum number of transmissions between two or more transmission frequencies.

In an embodiment, the method further includes determining a threshold associated with congestion measurement; and transmitting the threshold to determine the number of transmissions.

In an embodiment, determining the number of transmissions comprises determining a congestion measurement; and analyzing the congestion measurement with the threshold.

In an embodiment, the method further includes selecting a smallest number of transmission if the congestion measurement is below the threshold and a largest number of transmission if the congestion measurement is above the threshold.

In an embodiment, the method further includes determining, via an information broadcast, a plurality of periodicity values to be used for mismatches between two or more transmission frequencies.

In an embodiment, determining the plurality of periodicity values comprises

mapping the network to a plurality of parameters including traffic buffer size associated with a user device.

In an embodiment, there is provided a computer program comprising instructions which, when the program is executed by a computer, cause the computer to carry out the method of the first aspect.

In an embodiment, there is provided a computer readable storage medium having data stored therein representing software executable by a computer, the software including instructions, when executed by the computer, to carry out the method of the first aspect.

In an embodiment, there is provided an apparatus for resource allocation in a network comprising: a first module configured to receive at least one input signal; a second module configured to at least one of process and facilitate the method of the first aspect to generate at least one output signal; and a third module configured to communicate at least one output signal, wherein the output signal corresponds to a control signal for resource allocation.

In an embodiment, the apparatus corresponds to a User Equipment (UE) communicable with a device corresponding to a base station, and wherein the base station corresponds to a Next generation Node B (gNB) configured to communicate the at least one input signal to the UE.

In an embodiment, there is provided a system comprising: at least one apparatus(es); and at least one device(s), wherein the apparatus(es) and the device(s) are capable of being coupled via at least one of wired coupling and wireless coupling.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Embodiments of the disclosure are described hereinafter with reference to the following drawings, in which:

FIG. 1A shows a schematic diagram illustrating a system for resource allocation in a network which can include at least one apparatus, according to an embodiment of the invention.

FIG. 1B to FIG. 1E show example scenarios in association with the system of FIG. 1A, according to an embodiment of the invention.

FIG. 2 shows a schematic diagram illustrating the apparatus of FIG. 1A in further detail, according to an embodiment of the invention.

FIG. 3 shows a method in association with the system of FIG. 1A, according to an embodiment of the invention.

### DETAILED DESCRIPTION

The present specification discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the mobile telephone system. The computer program when loaded and executed on such a computer effectively results in an apparatus that implements the steps of the preferred method.

In some embodiments, a more general term “network node” may be used and may correspond to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. Mobile Switching Center (MSC), Mobility Management Entity (MME), etc), Operations & Maintenance (O&M), Operations Support System (OSS), Self Optimized Network (SON), positioning node (e.g. Evolved-Serving Mobile Location Centre (E-SMLC)), Minimization of Drive Tests (MDT), test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category MI, UE category M2, ProSe UE, V2V UE, V2X UE, etc.

The present disclosure generally contemplates the facilitation and optimization of a network (for example in association with 3GPP based standard/specification etc.) and/or user equipment (UE) efficiency and mobility (for example energy efficiency or power saving), in accordance with an embodiment of the invention. Specifically, the present disclosure contemplates the possibility of resource allocation in a network for a UE (or a user device), in connection with 3GPP standard(s).

The present disclosure generally contemplates there can be many options for resource allocation or resource reservation in a New Radio (NR) Sidelink (SL) resource (re) selection procedure. One example of an option includes a physical (PHY) layer of NR SL module excluding NR SL candidate resources overlapping with Long Term Evolution (LTE) SL reserved resources by other LTE SL User Equipment (UE) when the SL Reference Signal Received Power (RSRP) value associated with the LTE SL reserved resources is higher than a SL RSRP threshold. The SL RSRP threshold can be derived based on LTE SL priority of other LTE SL UE and NR SL priority for NR SL transmission. The present disclosure contemplates the above option can be adopted when determining candidate resource set for NR SL considering the LTE SL reserved resources by other LTE SL UE.

The present disclosure contemplates the above-discussed initial SL RSRP threshold can include one of the following: Alt 1 where the NR SL RSRP threshold list is (pre) configured in a NR SL resource pool; Alt 2 where the LTE SL RSRP threshold list is (pre) configured in a LTE SL resource pool; Alt 3 where the SL RSRP threshold list is separately (pre) configured for dynamic resource pool sharing; and Alt 4 where the SL RSRP threshold list is separately (pre) configured for dynamic resource pool sharing. In Alt 4, a different SL RSRP threshold list may also be (pre) configured for selecting single slot resources in NR SL slots with NR Physical Sidelink Feedback Channel (PSFCH).

The present disclosure further contemplates in a LTE SL periodic reserved resources by other LTE SL UE, the time-and-frequency resources of LTE SL reserved resources by other LTE SL UE when determining the LTE SL reserved resources can be repeated Q times according to the LTE SL resource reservation period. The present disclosure contemplates that FFS details can include at least a determination of the formula of Q from different technical specifications (TS), for example Section 14.1.1.6 in LTE TS 36.213 or Section 8.1.4 in NR TS 38.214. The present disclosure contemplates the PHY layer of NR module can apply the above-discussed procedure in for example, Step 6 in Section 8.1.4 of NR TS 38.214.

The present disclosure contemplates the PHY layer of NR SL module can further exclude NR SL candidate resources in periodic resource reservation of NR

SL transmission. The NR SL periodic resources can overlap with LTE SL reserved resources by other LTE SL UE when the SL RSRP value associated with the LTE SL reserved resources is higher than a SL RSRP threshold, which is in accordance to, for example condition c in Step 6 in Section 8.1.4 of NR TS 38.214.

The present disclosure contemplates the possibility that the information relevant to LTE SL reserved resources by other LTE SL UE used in the above procedure can be shared from LTE SL module to NR SL module and FFS on whether or how LTE SL RSRP can be applied.

The present disclosure also contemplates in a dynamic resource pool sharing, candidate information shred by the LTE SL module to the NR SL module may include one or more of the following parameters: time and frequency locations of reserved resources by the other LTE UEs that are determined based on decoded Sidelink Control Information (SCIs); SL RSRP measurement results; resource reservation periods based on decoded SCI and for own LTE SL transmissions; priority based on decoded SCI and for own LTE SL transmissions; time and frequency location of resources used for own LTE SL transmissions; candidate resource set SA or SB; SL Received Signal Strength Indicator (RSSI) measurements; LTE logical subframe related information; and resources corresponding to half-duplex subframes which are not monitored by the LTE SL.

In the above manner, resource reservation periods can be determined which can reduce time wasting and delay. Power saving and energy consumption efficiency can possibly be facilitated in the network, in accordance with an embodiment of the invention.

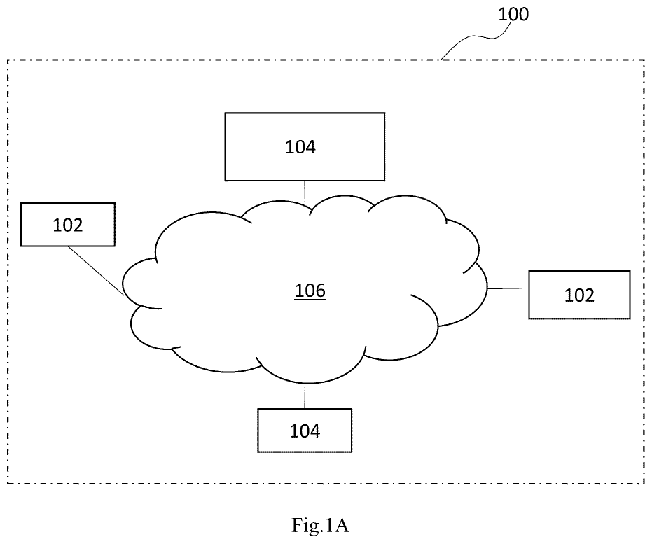

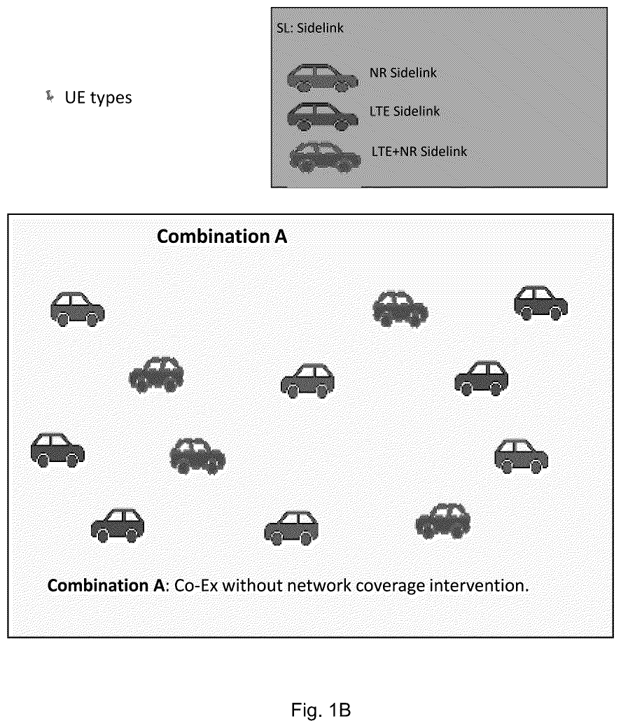

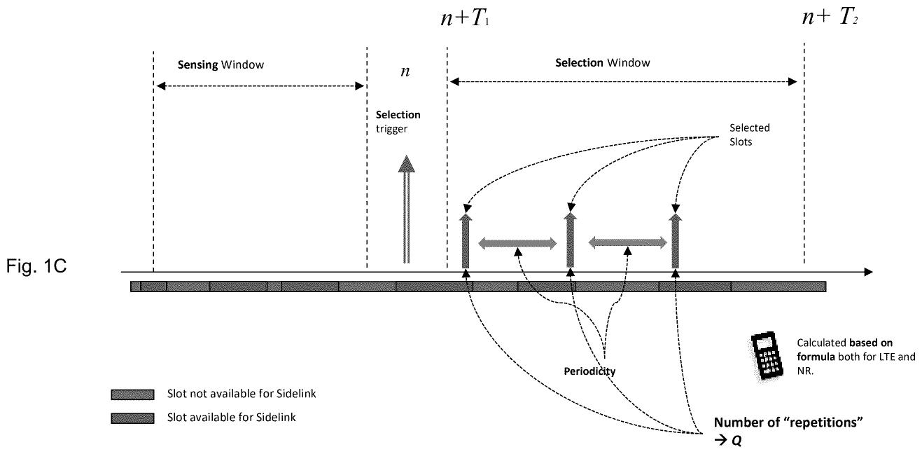

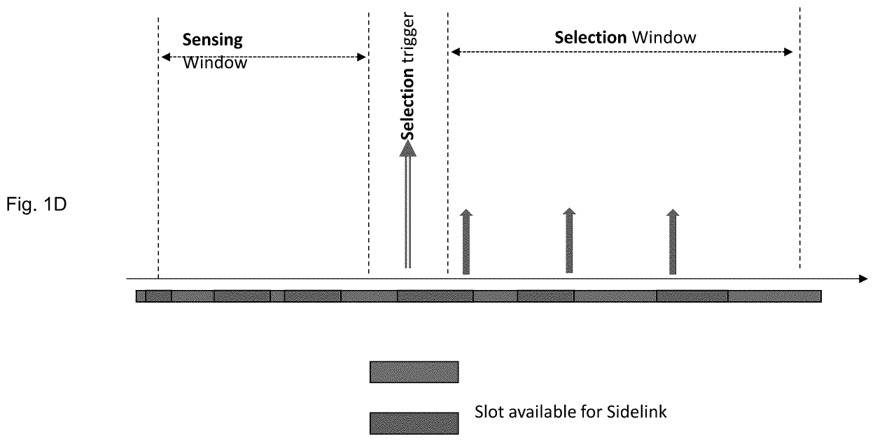

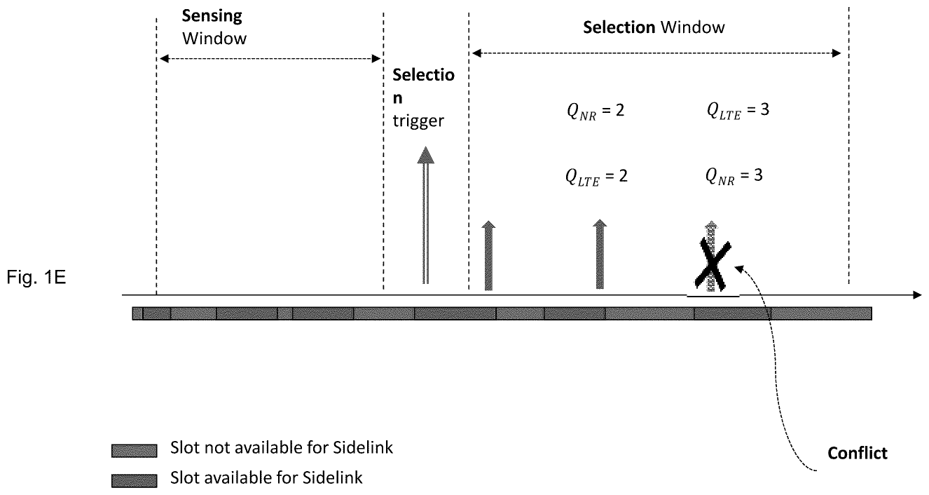

The foregoing will be discussed in further detail with reference to FIG. 1 to FIG. 3 hereinafter.

Referring to FIG. 1A, a schematic diagram illustrating a system 100 for resource allocation in a network is shown, according to an embodiment of the invention. The system 100 can, for example, be suitable for facilitating energy and improve power efficiency, in accordance with an embodiment of the invention.

As shown, the system 100 can include one or more apparatuses 102, at least one device 104 and, optionally, a communication network 106, in accordance with an embodiment of the invention.

The apparatus(es) 102 can be coupled to the device(s) 104. Specifically, the apparatus(es) 102 can, for example, be coupled to the device(s) 104 via the communication network 106, in accordance with an embodiment of the invention.

In one embodiment, the apparatus(es) 102 can be coupled to the communication network 106 and the device(s) 104 can be coupled to the communication network 106. Coupling can be by manner of one or both of wired coupling and wireless coupling. The apparatus(es) 102 can, in general, be configured to communicate with the device(s) 104 via the communication network 106, according to an embodiment of the invention.

The apparatus(es) 102 can, for example, be associated with or correspond to or include one or more user equipment (UE) or user device, which can carry one or more computers, in accordance with an embodiment of the invention. For example, an apparatus 102 can correspond to a UE (or user device) carrying at least one computer (e.g. an electronic device or module having computing capabilities such as an electronic mobile device which can be carried into a vehicle or an electronic module which can be installed in a vehicle, in accordance with an embodiment of the invention) which can be configured to perform one or more processing tasks in association with adaptive/dynamic/gradual control, in accordance with an embodiment of the invention.

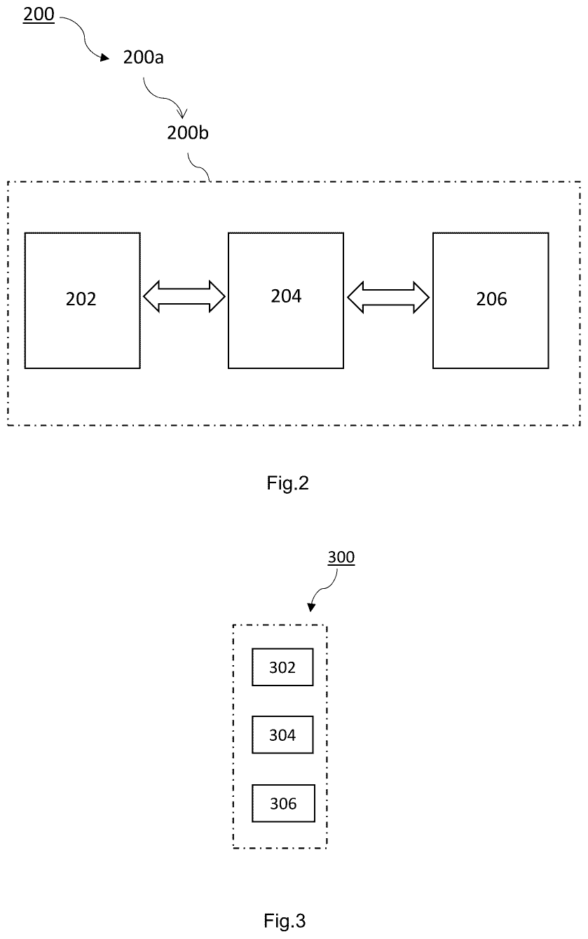

In an embodiment, the apparatus(es) 102 can, for example, be configured to receive one or more input signals and perform at least one processing task based on the input signal(s) in a manner to generate one or more output signals. The input signal(s) can, for example, be communicated from the device(s) 104 and received by the apparatus(es) 102, in accordance with an embodiment of the invention. The input signal can be associated with resource reservation. As a possible option, the output signal(s) can, for example, be communicated from the apparatus(es) 102, in accordance with an embodiment of the invention. The output signal may correspond to a control signal for resource allocation. The apparatus(es) 102 will be discussed later in further detail with reference to FIG. 2, according to an embodiment of the invention.

The device(s) 104 can, for example, be associated with/correspond to at least one base station, where the at least one base station can be a Next Generation Node B (gNB). Moreover, the device(s) 104 can, for example, be configured to carry/be associated with/include one or more computers (e.g., an electronic device/module having computing capabilities) which can, for example, be configured to perform one or more processing tasks in association with the base station. The device(s) 104 can be configured to generate one or more input signals which can be communicated to the apparatus(es) 102, in accordance with an embodiment of the invention. This will be discussed later in further detail in the context of an example scenario, in accordance with an embodiment of the invention.

The communication network 106 can, for example, correspond to an Internet communication network, a cellular-based communication network, a wired-based communication network, a Global Navigation Satellite System (GNSS) based communication network, a wireless-based communication network, or any combination thereof. Communication (e.g., between the apparatuses 102 and/or between the apparatus(es) 102 and the device(s) 104) via the communication network 106 can be by manner of one or both of wired communication and wireless communication.

As mentioned, the apparatus(es) 102 can, for example, be configured to receive at least one input signal and perform at least one processing task in association with dynamic/adaptive/gradual control on the input signal(s) in a manner so as to generate at least one output signal. Moreover, the device(s) 104 can, for example, be configured to generate (and communicate) the input signal(s) to the apparatus(es) 102, in accordance with an embodiment of the invention. This will be discussed, in accordance with an embodiment of the invention, in the context of an example scenario with reference to FIG. 1B to FIG. 1E, hereinafter.

FIG. 1B to FIG. 1E show example scenarios in association with the system of FIG. 1A, according to an embodiment of the invention. Specifically, FIG. 1B shows an example of a combination of Resource Reservation in New Radio (NR) sidelink (SL) and Long Term Evolution (LTE) SL Co-channel Co-existence. As shown in FIG. 1B, combination A (or Mode 2) can include different types of user equipment UE (or user devices) co-existing without network coverage intervention. The different types of UE (or user device) may include NR SL, LTE SL and/or LTE and NR SL. The NR SL reservation can be based on other (e.g. not-collocated) LTE SL periodic reservation.

FIG. 1C shows an example embodiment of a framework for resource reservation having a sensing window and a selection window. The figure shows slots not available for sidelink and also the slots available for sidelink. The framework also shows a sensing window, a selection trigger n and a selection window defined by n+T₁ and n+T₂, where T₁ and T₂ may be two parameters that can be determined by the UE (or user device) implementation. The arrows of the selected slots in the selection window may indicate the slots available for sidelink as compared to the selection trigger. The periodicity between each selected slot can represent the number of repetitions and can define Q, which can be calculated based on a formula both for LTE and NR, for example Section 14.1.1.6 in LTE TS 36.213 and Section 8.1.4 in NR TS 38.214.

In an example embodiment, the UE (or user device) procedure for determining the subset of resources to be reported to higher layers in Physical Sidelink Shared Channel (PSSCH) resource selection in sidelink resource allocation mode 2 can be as follows. The UE (or user device) receives sidelink control information SCI (e.g. SCI 1-A) in the form P_{rsvp_RX}, where P_{rsvp_RX} indicates the resource reservation period. The UE (or user device) may perform the Reference Signal Received Power (RSRP) measurement Th(prlo_{RX}, prlo_{TX}). The determination of Q may then be determined. In most cases of NR, Q may be determined by

$$Q = ⌈ \frac{{T}_{scal}}{{P}_{rsvp \_ RX}} ⌉ ,$$

where T_{scal} may relate to T₂ and P_{rsvp_RX} may relate to resource reservation period. In most cases of LTE, Q may be determined by

$$Q = \frac{1}{{P}_{RX}} .$$

FIG. 1D shows an example embodiment of a framework for resource reservation including slots available for sidelink while FIG. 1E shows an example embodiment of a conflict in the selection of the window. In both figures, the value of Q can be calculated in a different manner in LTE and NR. This may affect the co-channel co-existence of NR-based sidelink and LTE-based sidelink negatively and may result in conflict in resource selection. The present disclosure thus contemplates the determination of the formula of Q can be from different technical specifications (TS), for example Section 14.1.1.6 in LTE TS 36.213 or Section 8.1.4 in NR TS 38.214

The above-described aspect(s) of the system 100 of the present invention can also apply analogously (all) the aspect(s) of a below described apparatus 102 of the present invention. Likewise, all below described aspect(s) of the apparatus 102 of the invention can also apply analogously (all) the aspect(s) of above-described system 100 of the invention.

The aforementioned apparatus(es) 102 or User Equipment (UE) will be discussed in further detail with reference to FIG. 2 hereinafter.

Referring to FIG. 2, a schematic diagram illustrating an apparatus 102 is shown in further detail in the context of an example implementation 200, according to an embodiment of the invention.

In the example implementation 200, the apparatus 102 can correspond to an electronic module 200a. The electronic module 200a can, in one example, correspond to a mobile device which can, for example, be carried into the vehicle by a user, in accordance with an embodiment of the invention. In another example, the electronic module 200a can correspond to an electronic device which can be installed/mounted in the vehicle, in accordance with an embodiment of the invention.

In this regard, the electronic module 200a can be considered to be carried by the vehicle (e.g., either carried into the vehicle by a user or installed/mounted in the vehicle).

It is contemplated that the electronic module 200a can be capable of performing one or more processing tasks in association with adaptive/dynamic/gradual control related processing, in accordance with an embodiment of the invention.

The electronic module 200a can, for example, include a casing 200b. Moreover, the electronic module 200a can, for example, carry any one of a first module 202, a second module 204, a third module 206, or any combination thereof.

In one embodiment, the electronic module 200a can carry a first module 202, a second module 204 and/or a third module 206. In a specific example, the electronic module 200a can carry a first module 202, a second module 204 and a third module 206, in accordance with an embodiment of the invention.

In this regard, it is appreciable that, in one embodiment, the casing 200b can be shaped and dimensioned to carry any one of the first module 202, the second module 204 and the third module 206, or any combination thereof.

The first module 202 can be coupled to one or both of the second module 204 and the third module 206. The second module 204 can be coupled to one or both of the first module 202 and the third module 206. The third module 206 can be coupled to one or both of the first module 202 and the second module 204. In one example, the first module 202 can be coupled to the second module 204 and the second module 204 can be coupled to the third module 206, in accordance with an embodiment of the invention. Coupling between the first module 202, the second module 204 and/or the third module 206 can, for example, be by manner of one or both of wired coupling and wireless coupling. Each of the first module 202, the second module 204 and the third module 206 can correspond to one or both of a hardware-based module and a software-based module, according to an embodiment of the invention.

In one example, the first module 202 can correspond to a hardware-based receiver which can be configured to receive one or more input signals. The input signal(s) can, for example, be communicated from the device(s) 104 (or base station e.g., a gNB), in accordance with an embodiment of the invention.

The second module 204 can, for example, correspond to a hardware-based processor which can be configured to perform one or more processing tasks (e.g., in a manner so as to generate one or more output signals) as will be discussed later in further detail with reference to FIG. 3, in accordance with an embodiment of the invention.

The third module 206 can correspond to a hardware-based transmitter which can be configured to communicate one or more output signals from the electronic module 200a. The output signal(s) can, for example, include one or more instructions/commands/control signals in association with the aforementioned dynamic/adaptive/gradual control configuration/determination strategy so as to facilitate efficiency (e.g., power/energy efficiency and/or communication efficiency), in accordance with an embodiment of the invention. For example, the output signal(s) can be a control signal(s) for resource allocation in a network.

The present disclosure contemplates the possibility that the first and second modules 202, 204 can be an integrated software-hardware based module, for example, an electronic part which can carry a software program or algorithm in association with receiving and processing functions or an electronic module programmed to perform the functions of receiving and processing. The present disclosure further contemplates the possibility that the first and third modules 202, 206 can be an integrated software-hardware based module, for example an electronic part which can carry a software program or algorithm in association with receiving and transmitting functions or an electronic module programmed to perform the functions of receiving and transmitting. The present disclosure yet further contemplates the possibility that the first and third modules 202, 206 can be an integrated hardware module, for example a hardware-based transceiver, capable of performing the functions of receiving and transmitting.

The UE can, for example, be further configured to process the input signal(s), as will be discussed later in further detail with reference to FIG. 3, in a manner so as to generate one or more output signals in a manner so as to facilitate efficiency, for example power efficiency or energy efficiency, in accordance with an embodiment of the invention. In one specific example, the output signal(s) can include one or more control signals to facilitate some form of dynamic/adaptive/gradual control configuration/determination strategy so as to facilitate efficiency, for example power efficiency or energy efficiency, in accordance with an embodiment of the invention. For example, the output signal(s) can be a control signal(s) for resource allocation in a network.

The above-described aspect(s) of the apparatus 102 of the present invention can also apply analogously (all) the aspect(s) of a below described processing/communication method of the present invention. Likewise, all below described aspect(s) of the method of the invention can also apply analogously (all) the aspect(s) of above described apparatus 102 of the invention. It is to be appreciated that these remarks apply analogously to the earlier discussed system 100 of the present disclosure.

Referring to FIG. 3, a method 300 (or a communication method) for determining a signal transmission duration, in association with the system 100 is shown, according to an embodiment of the invention.

The method 300 can, for example, be suitable for facilitating energy efficiency, network optimization and power saving in accordance with an embodiment of the invention.

The method 300 can include any one of an input step 302, a processing step 304 and an output step 306, or any combination thereof, in accordance with an embodiment of the invention.

In an embodiment, the processing method 300 can include the input step 302. In another embodiment, the processing method 300 can include the input step 302 and the processing step 304. In another embodiment, the processing method 300 can include the input step 302, the processing step 304 and the output step 306. In yet another embodiment, the processing method 300 can include the processing step 304 and one or both of the input step 302 and the output step 306. In yet a further embodiment, the processing method 300 can include the input step 302, the processing step 304 and the output step 306. In yet a further additional embodiment, the processing method 300 can include the processing step 304. In yet another further additional embodiment, the processing method 300 can include any one of or any combination of the input step 302, the processing step 304 and the output step 306 (i.e., the input step 302, the processing step 304 and/or the output step 306).

With regard to the input step 302, one or more input signal(s) can be received. For example, the input signal(s) can be communicated from the device(s) 104 and can be received by an apparatus 102, in accordance with an embodiment of the invention.

The input step 302 can include receiving at least one input signal associated with resource reservation and may be transmitted from the device 104.

With regard to the processing step 304, at least a processing task can be performed in association with the received input signal(s) in a manner so as to generate one or more output signals, in accordance with an embodiment of the invention.

The processing step 304 may include at least one of: determining a number of transmissions and a time period between each of the transmissions based on the received signal; transmitting resources based on the number of transmissions and the time period; allocating resources for transmission based on the number of transmissions and the time period; and determining the number of transmissions based on a maximum number of transmissions between two or more transmission frequencies.

The processing step 304 may also include determining a threshold associated with congestion measurement; transmitting the threshold to determine the number of transmissions; determining a congestion measurement; and analyzing the congestion measurement with the threshold. It may further include selecting a smallest number of transmission if the congestion measurement is below the threshold and a largest number of transmission if the congestion measurement is above the threshold; determining, via an information broadcast, a plurality of periodicity values to be used for mismatches between two or more transmission frequencies; and mapping the network to a plurality of parameters including traffic buffer size associated with a user device.

In an example embodiment, the number of transmissions (Q) for Release 18 NR V2X modules with Co-Existence scenarios can be determined using the formula

$${Q}_{NR , Rel 18} = max \{ {Q}_{NR} , {Q}_{LTE} \}$$

where Q_{NR} may be determined according to New Radio (NR) Technical Specification (TS) 38.214 and Q_{LTE} may be determined according to Long Term Evolution (LTE) TS 36.213.

Alternatively, the number of transmissions (Q) for Release 18 NR V2X modules with Co-Existence scenarios can be determined using the formula Q_{NR,Rel18} where the smallest Q is used if a congestion measurement is below a pre-determined threshold and the largest Q is used if a congestion measurement is above the pre-determined threshold. The threshold can be pre-determined by the device 104 (or base station or gNB) and signaled or updated periodically by the device (or base station or gNB) where Mode 2 is assumed.

In a further embodiment, the number of transmissions (Q) for Release 18 NR modules with Co-Existence scenarios can be determined by having the network (or base station or gNB) indicate using broadcast information valid periodicity values to be used to indicate NR-LTE Q mismatches. An example could be mapping of the network to one or more parameters, such as traffic buffer size while considering specific UE (or user device) requirements. This can be possible even in mode 2 operation and at least under coverage conditions.

With regards to the output step 306, the output signal(s) can, for example, be communicated, as an option, in accordance with an embodiment of the invention. For example, the output signal(s) can optionally be communicated from the apparatus 102. In a more specific example, the output signal(s) can optionally be communicated from the apparatus 102 to one or both of at least one device 104 and another apparatus 102, in accordance with an embodiment of the invention. In an embodiment, the apparatus 102 (or UE) may also perform the input step 302, the processing step 304 and the output step 306.

The present disclosure further contemplates a computer program (not shown) which can include instructions which, when the program is executed by a computer (not shown), cause the computer to carry out the input step 302, the processing step 304 and/or the output step 306 as discussed with reference to the method 300. For example, the computer program can include instructions which, when the program is executed by a computer, cause the computer to carry out the input step 302 and/or the processing step 304, in accordance with an embodiment of the invention.

The present disclosure yet further contemplates a computer readable storage medium (not shown) having data stored therein representing software executable by a computer (not shown), the software including instructions, when executed by the computer, to carry out the input step 302, the processing step 304 and/or the output step 306 as discussed with reference to the method 300. For example, the computer readable storage medium can have data stored therein representing software executable by a computer, the software including instructions, when executed by the computer, cause the computer to carry out the input step 302 and/or the processing step 304, in accordance with an embodiment of the invention.

Further in view of the foregoing, it is appreciable that the present disclosure generally contemplates an apparatus 102 for resource allocation in a network which can include a first module 202, a second module 204 and/or a third module 206.

The first module 202 can be configured to receive one or more input signals. The input signal(s) can, for example, be associated with resource reservation in a network.

The second module 204 can be configured to process and/or facilitate processing of the input signal(s) according to the method 300 as discussed earlier to generate one or more output signals.

The third module 206 can be configured to communicate one or more output signals. The output signal(s) can, for example, correspond to one or more control signals for resource allocation in a network.

In one embodiment, the apparatus 102 can correspond to a User Equipment (UE) which can communicate with a device 104 corresponding to a base station. The base station can, for example, correspond to a Next generation Node B (gNB) which can be configured to communicate one or more signals (e.g., input signal(s)) to the UE.

Yet further in view of the foregoing, it is appreciable that the present disclosure generally contemplates a system 100 which can include one or more apparatuses 102 and one or more devices 104. The apparatus(es) 102 and the device(s) 104 can, for example, be capable of being coupled via wired coupling and/or wireless coupling.

It should be appreciated that the embodiments described above can be combined in any manner as appropriate (e.g., one or more embodiments as discussed in the “Detailed Description” section can be combined with one or more embodiments as described in the “Summary of the Invention” section).

It should be further appreciated by the person skilled in the art that variations and combinations of embodiments described above, not being alternatives or substitutes, may be combined to form yet further embodiments.

In one example, the possibility of the output signal(s) being communicated from the apparatus(es) 102 was discussed. It is appreciable that the output signal(s) need not necessarily be communicated from the apparatus(es) 102. Specifically, the possibility that the output signal(s) need not necessarily be communicated outside of the apparatus(es) 102 is contemplated, in accordance with an embodiment of the invention. More specifically, the output signal(s) can, for example, correspond to internal command(s)/instruction(s) (e.g., communicated only within an apparatus 102) for adaptively controlling operational configuration of an apparatus 102, in accordance with an embodiment of the invention.

In the foregoing manner, various embodiments of the disclosure are described for addressing at least one of the foregoing disadvantages. Such embodiments are intended to be encompassed by the following claims and are not to be limited to specific forms or arrangements of parts so described and it will be apparent to one skilled in the art in view of this disclosure that numerous changes and/or modification can be made, which are also intended to be encompassed by the following claims.

### Abbreviations

BWP Bandwidth part
CBG Code block group
CLI Cross Link Interference
CP Cyclic prefix
CQI Channel quality indicator
CPU CSI processing unit
CRB Common resource block
CRC Cyclic redundancy check
CRI CSI-RS Resource Indicator
CSI Channel state information
CSI-RS Channel state information reference signal
CSI-RSRP CSI reference signal received power
CSI reference signal received quality CSI-RSRQ
CSI-SINR CSI signal-to-noise and interference ratio
CW Codeword
DCI Downlink control information
DL Downlink
DM-RS Demodulation reference signals
DRX Discontinuous Reception
EPRE Energy per resource element
IAB-MT Integrated Access and Backhaul-Mobile Terminal
L1-RSRP Layer 1 reference signal received power
LI Layer Indicator
LTE Long Term Evolution
MCS Modulation and coding scheme
NR New Radio
PHY Physical
PDCCH Physical downlink control channel
PDSCH Physical downlink shared channel
PSFCH Physical sidelink feedback channel
PSS Primary Synchronization signal
PSSCH Physical Sidelink Shared Channel
PUCCH Physical uplink control channel
QCL Quasi co-location
PMI Precoding Matrix Indicator
PRB Physical resource block
PRG Precoding resource block group
PRS Positioning reference signal
Phase-tracking reference signal PT-RS
RB Resource block
RBG Resource block group
RI Rank Indicator
RIV Resource indicator value
RS Reference signal
RSRP Reference Signal Received Power
RSSI Received Signal Strength Indicator
SC Sidelink control information
SL Sidelink
SLIV Start and length indicator value
SR Scheduling Request
SRS Sounding reference signal
SS Synchronization signal
SSS Secondary Synchronization signal
SS-RSRP SS reference signal received power
SS-RSRQ SS reference signal received quality
SS-SINR SS signal-to-noise and interference ratio
TB Transport Block
TCI Transmission Configuration Indicator
TDM Time division multiplexing
UE User equipment
UL Uplink

1. A method for resource allocation in a network, the method comprising:
receiving a signal associated with resource reservation;
determining a number of transmissions and a time period between each of the transmissions based on the received signal; and
transmitting resources based on the number of transmissions and the time period.

2. The method according to claim 1, further comprising allocating resources for transmission based on the number of transmissions and the time period.

3. The method according to claim 1, wherein determining a number of transmissions comprises determining the number of transmissions based on a maximum number of transmissions between two or more transmission frequencies.

4. The method according to claim 1, further comprising:
determining a threshold associated with congestion measurement; and
transmitting the threshold to determine the number of transmissions.

5. The method according to claim 4, wherein determining the number of transmissions comprises:
determining a congestion measurement; and
analyzing the congestion measurement with the threshold.

6. The method according to claim 5, further comprising selecting a smallest number of transmission if the congestion measurement is below the threshold and a largest number of transmission if the congestion measurement is above the threshold.

7. The method according to claim 1, further comprising determining, via an information broadcast, a plurality of periodicity values to be used for mismatches between two or more transmission frequencies.

8. The method according to claim 7, wherein determining the plurality of periodicity values comprises mapping the network to a plurality of parameters including traffic buffer size associated with a user device.

9. A computer program comprising instructions which, when the program is executed by a computer, cause the computer to carry out the method of claim 1.

10. A non-transitory computer readable storage medium having data stored therein representing software executable by a computer, the software including instructions, when executed by the computer, to carry out the method of claim 1.

11. An apparatus for resource allocation in a network comprising:
a first module configured to receive at least one input signal;
a second module configured to at least one of process and facilitate the method of claim 1 to generate at least one output signal; and
a third module configured to communicate at least one output signal,
wherein the output signal corresponds to a control signal for resource allocation.

12. The apparatus according to claim 11,
wherein the apparatus corresponds to a User Equipment communicable with a device corresponding to a base station, and
wherein the base station corresponds to a Next generation Node B configured to communicate the at least one input signal to the UE.

13. A system (100) comprising:
at least one apparatus according to claim 11; and
at least one device corresponding to a base station, wherein the base station corresponds to a Next generation Node B configured to communicate the at least one input signal to a User Equipment,
wherein the apparatus and the device are capable of being coupled via at least one of wired coupling and wireless coupling.
